(19) United States
(12) Patent Application Publication
(10) Pub. No.: US 2006/0290272 A1
(43) Pub. Date: Dec. 28, 2006

(54) Enhancement of light extraction using gel layers with excavations

(75) Inventor: Lukas Haenichen, Neu-Anspach (GE)

Correspondence Address: FISH & RICHARDSON P.C., PO BOX 1022, MINNEAPOLIS, MN, 55440-1022, US

(73) Assignee: Osram Opto Semiconductors GmbH

(21) Appl. No.: 11/159,739

(22) Filed: Jun. 23, 2005

(51) Int. Cl. H01J 1/62; H01J 63/04

(52) U.S. Cl. 313/504

(57) ABSTRACT

An apparatus such as a light source is disclosed which has an OLED device and a refractive layer disposed on the substrate or transparent electrode of said OLED device and on the exterior of said OLED device. The refractive layer contains features which have an inner region with a refractive index less than the refractive index of the non-feature regions of the refractive layer.

### GOVERNMENT RIGHTS

This invention was made with Government support under Contract No. DE-FC26-04NT41947 awarded by the Department of Energy. The Government may have certain rights in the invention.

### BACKGROUND

Display and lighting systems based on LEDs (Light Emitting Diodes) have a variety of applications. Such display and lighting systems are designed by arranging a plurality of photo-electronic elements (“elements”) such as rows of individual LEDs. LEDs that are based upon semiconductor technology have traditionally used inorganic materials, but recently, the organic LED (“OLED”) has come into vogue. Examples of other elements/devices using organic materials include organic solar cells, organic transistors, organic detectors, and organic lasers.

An organic OLED is typically comprised of two or more thin organic layers (e.g., an electrically conducting organic layer and an emissive organic layer where the emissive organic layer emits light) which separate an anode and a cathode. Under an applied forward potential, the anode injects holes into the conducting layer, while the cathode injects electrons into the emissive layer. The injected holes and electrons each migrate (under the influence of an externally applied electric field) toward the oppositely charged electrode and produce an electroluminescent emission upon recombination in the emissive layer. Similar device structure and device operation applies for OLEDs consisting of small molecule organic layers and/or polymeric organic layers. Each of the OLEDs can be a pixel element in a passive/active matrix OLED display or an element in a general area light source and the like. The construction of OLED light sources and OLED displays from individual OLED elements or devices is well known in the art. The displays and light sources may have one or more common layers such as common substrates, anodes or cathodes and one or more active/passive organic layers sandwiched in between to emit light in particular spectra. They may also consist of photo-resist or electrical separators, bus lines, charge transport and/or charge injection layers, and the like. Typically, a transparent or semi-transparent glass substrate is used in bottom-emitting OLED devices.

Overall efficiency of the OLED lighting sources is reduced due to total inner reflection at the emitting plane which is the glass substrate. Total inner reflection occurs when the generated light reaches the border above the critical angle. There is a need to eliminate or reduce the effect of total inner reflection in order to enhance light extraction.

### BRIEF DESCRIPTION OF THE DRAWINGS

FIG. 1 shows a cross-sectional view of an embodiment of an EL device according to at least one embodiment of the invention.

FIG. 2 shows a cross-sectional view of exemplary light emission in accordance with at least one embodiment of the invention.

FIG. 3 illustrates the luminance enhancement compared to angular offset utilizing one or more embodiments of the invention.

FIG. 4 illustrates the relative luminance improvement at various viewing angles when the invention is utilized.

FIG. 5 shows a top view luminance distribution measured on an OLED white light source with (left domain, measuring points approx. 1 . . . 400) and without (right domain, measuring points approx 401 . . . 800) the invention.

FIG. 6 illustrates one or more embodiments of the invention.

FIG. 7 illustrates angular dependence of emitted spectra for OLED devices without a refractive layer.

FIG. 8 illustrates angular dependence of emitted spectra for OLED devices with a refractive layer in accordance with the invention.

### DETAILED DESCRIPTION

In at least one embodiment of the invention, an electroluminescent (EL) device is disclosed which utilizes 1) an OLED device including a transparent substrate; and 2) a refractive layer with features, the refractive layer disposed in the path of light emission from the OLED device and on the outside of the OLED device on the exterior side of the substrate, the features of the refractive layer have an inner region with a lower index of refraction than the remaining regions of the refractive layer. In at least one embodiment of the invention, the refractive layer is made from an optical adhesive. In at least one embodiment of the invention, the features are bubbles of material with an inner region having a lower refractive index than other regions of the refractive layer. The regions of the refractive layer surrounding these features (“non-feature regions”) will have a refractive index roughly the same as or in some instances, greater than the refractive index as the substrate of the OLED device. In other embodiments of the invention, the features are hollow excavations containing no added material and thus with a refractive index roughly equal to air. In still other embodiments of the invention, an electroluminescent (EL) device is disclosed which utilizes 1) an OLED device including a transparent second electrode; and 2) a refractive layer with features, the refractive layer disposed in the path of light emission from the OLED device and on the outside of the OLED device.

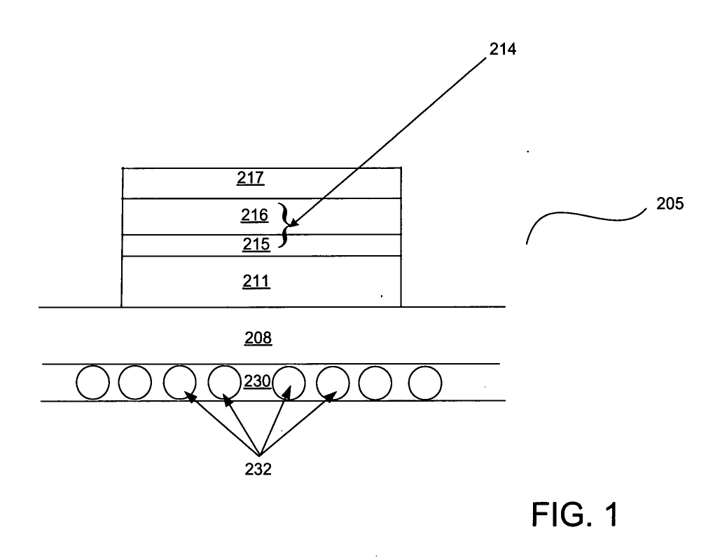

FIG. 1 shows a cross-sectional view of an embodiment of an EL device 200 according to at least one embodiment of the invention. The EL device 200 includes an OLED device 205. OLED device 205 includes substrate 208 and a first electrode 211 on the substrate 208. The first electrode 211 may be patterned for pixilated applications or un-patterned for backlight or other general lighting applications. The OLED device 205 also includes a semiconductor stack 214 on the first electrode 211. The semiconductor stack 214 includes at least the following: (1) a hole injection layer/anode buffer layer (HIL/ABL) 215 and (2) an active light emitting layer (EML) 216.

As shown in FIG. 1, the OLED device 205 is a bottom-emitting device. As a bottom-emitting device, the first electrode 211 would act as an anode, and the HIL/ABL 215 would be disposed on the first electrode 211, and the EML 216 would be disposed on the HIL/ABL 215. The OLED device 205 also includes a second electrode 217 on the semiconductor stack 214. Other layers than that shown in FIG. 1 may also be added such as insulating layers, barrier layers, electron/hole injection and blocking layers, getter layers, and so on. In accordance with the invention, a refractive layer 230 is disposed on the outside of the OLED device 205. More specifically, in the configuration shown, the refractive layer 230 is disposed on the substrate 208. The OLED device 205 and the refractive layer 230 together comprise the EL device 200. Exemplary embodiments of these layers are described in greater detail below.

Substrate 208:

The substrate 208 can be any material, which can support the additional layers and electrodes, and is transparent or semi-transparent to the wavelength of light emitted by the OLED device 205. Alternatively, the substrate 208 can be opaque (when used in top-emitting devices), see FIG. X. Preferable substrate materials include glass, quartz, silicon, and plastic, preferably, thin, flexible glass. The preferred thickness of the substrate 208 depends on the material used and on the application of the device. The substrate 208 can be in the form of a sheet or continuous film. The continuous film is used, for example, for roll-to-roll manufacturing processes which are particularly suited for plastic, metal, and metallized plastic foils.

First Electrode 211:

In the bottom-emitting configuration, the first electrode 211 functions as an anode (the anode is a conductive layer which serves as a hole-injecting layer). Typical anode materials include metals (such as platinum, gold, palladium, indium, and the like); metal oxides (such as lead oxide, tin oxide, indium-tin oxide, and the like); graphite; doped inorganic semiconductors (such as silicon, germanium, gallium arsenide, and the like); and doped conducting polymers (such as polyaniline, polypyrrole, polythiophene, and the like). Preferably, the first electrode 211 is comprised of indium-tin oxide (ITO).

The first electrode 211 is preferably transparent or semi-transparent to the wavelength of light generated by the OLED device 205. Preferably, the thickness of the first electrode 211 is from about 10 nanometers (“nm”) to about 1000 nm, more preferably from about 50 nm to about 200 nm, and most preferably is about 100 nm.

The first electrode layer 211 can typically be fabricated using any of the techniques known in the art for deposition of thin films, including, for example, vacuum evaporation, sputtering, electron beam deposition, or chemical vapor deposition, using for example, pure metals or alloys, or other film precursors.

HIL/ABL 215:

The HIL/ABL 215 has good hole conducting properties and is used to effectively inject holes from the first electrode 211 to the EML 216. The HIL/ABL 215 is made of polymers or small molecule materials or other organic or partially organic material. For example, the HIL/ABL 215 can be made from tertiary amine or carbazole derivatives both in their small molecule or their polymer form, conducting polyaniline (“PANI”), or PEDOT:PSS (a solution of poly(3,4-ethylenedioxythiophene) (“PEDOT”) and polystyrenesulfonic acid (“PSS”) (available as Baytron P from HC Starck). The HIL/ABL 215 can have a thickness from about 5 nm to about 1000 nm, and is conventionally used from about 50 to about 250 nm.

Other examples of the HIL/ABL 215 include any small molecule materials and the like such as plasma polymerized fluorocarbon films (CFx) with preferred thicknesses between 0.3 and 3 nm, copper phthalocyanine (CuPc) films with preferred thicknesses between 10 and 50 nm.

The HIL/ABL 215 can be formed using selective deposition techniques or nonselective deposition techniques. Examples of selective deposition techniques include, for example, ink jet printing, flex printing, and screen printing. Examples of nonselective deposition techniques include, for example, spin coating, dip coating, web coating, and spray coating. A hole transporting and/or buffer material is deposited on the first electrode 211 and then allowed to dry into a film. The dried film represents the HIL/ABL 215. Other deposition methods for the HIL/ABL 215 include plasma polymerization (for CFx layers), vacuum deposition, or vapour phase deposition (e.g. for films of CuPc).

EML 216:

The active light emissive layer (EML) 216 is comprised of an organic electroluminescent material which emits light upon application of a potential across first electrode 211 and second electrode 217. The EML may be fabricated from materials organic or organo-metallic in nature. As used herein, the term organic also includes organo-metallic materials. Light-emission in these materials may be generated as a result of fluorescence or phosphorescence. Examples of such organic electroluminescent materials include:

(i) poly(p-phenylene vinylene) and its derivatives substituted at various positions on the phenylene moiety;

(ii) poly(p-phenylene vinylene) and its derivatives substituted at various positions on the vinylene moiety;

(iii) poly(p-phenylene vinylene) and its derivatives substituted at various positions on the phenylene moiety and also substituted at various positions on the vinylene moiety; (iv) poly(arylene vinylene), where the arylene may be such moieties as naphthalene, anthracene, furylene, thienylene, oxadiazole, and the like;

(v) derivatives of poly(arylene vinylene), where the arylene may be as in (iv) above, and additionally have substituents at various positions on the arylene;

(vi) derivatives of poly(arylene vinylene), where the arylene may be as in (iv) above, and additionally have substituents at various positions on the vinylene;

(vii) derivatives of poly(arylene vinylene), where the arylene may be as in (iv) above, and additionally have substituents at various positions on the arylene and substituents at various positions on the vinylene;

(viii) co-polymers of arylene vinylene oligomers, such as those in (iv), (v), (vi), and (vii) with non-conjugated oligomers; and

(ix) polyp-phenylene and its derivatives substituted at various positions on the phenylene moiety, including ladder polymer derivatives such as poly(9,9-dialkyl fluorene) and the like;

(x) poly(arylenes) where the arylene may be such moieties as naphthalene, anthracene, furylene, thienylene, oxadiazole, and the like; and their derivatives substituted at various positions on the arylene moiety;

(xi) co-polymers of oligoarylenes such as those in (x) with non-conjugated oligomers;

(xii) polyquinoline and its derivatives;

(xiii) co-polymers of polyquinoline with p-phenylene substituted on the phenylene with, for example, alkyl or alkoxy groups to provide solubility; and

(xiv) rigid rod polymers such as poly(p-phenylene-2,6-benzobisthiazole), poly(p-phenylene-2,6-benzobisoxazole), polyp-phenylene-2,6-benzimidazole), and their derivatives.

Other organic emissive polymers such as those utilizing polyfluorene include that emit green, red, blue, or white light or their families, copolymers, derivatives, or mixtures thereof. Other polymers include polyspirofluorene-like polymers, their families, co-polymers and derivatives.

Alternatively, rather than polymers, small organic molecules that emit by fluorescence or by phosphorescence can serve as the organic electroluminescent layer. Examples of small-molecule organic electroluminescent materials include: (i) tris(8-hydroxyquinolinato)aluminum (Alq); (ii) 1,3-bis(N,N-dimethylaminophenyl)-1,3,4-oxidazole (OXD-8); (iii)-oxo-bis(2-methyl-8-quinolinato) aluminum; (iv) bis(2-methyl-8-hydroxyquinolinato)aluminum; (v) bis(hydroxybenzoquinolinato)beryllium (BeQ.sub.2); (vi) bis(diphenylvinyl)biphenylene (DPVBI); and (vii) arylamine-substituted distyrylarylene (DSA amine).

The thickness of the EML 216 can be from about 5 nm to about 500 nm, preferably, from about 20 nm to about 100 nm, and more preferably is about 75 nm. The EML 216 can be a continuous film that is non-selectively deposited (e.g. spin-coating, dip coating etc.) or discontinuous regions that are selectively deposited (e.g. by ink-jet printing). EML 216 may also be fabricated by vapor deposition, sputtering, vacuum deposition etc. as desired.

The EML 216 can composed of at least two light emitting elements chosen, for example, from those listed above. In the case of two light-emitting elements, the relative concentration of the host element and the dopant element can be adjusted to obtain the desired color. The EML 216 can be fabricated by blending or mixing the elements, either physically, chemically, or both. The EML 216 can emit light in any desired color and be comprised of polymers, co-polymers, dopants, quenchers, and hole transport materials as desired. For instance, the EML 216 can emit light in blue, red, green, orange, yellow or any desired combination of these colors and in some applications, may include a combination of emitting elements which produce white light.

In addition to active electroluminescent materials that emit light, EML 216 can also include materials capable of charge transport. Charge transport materials include polymers or small molecules that can transport charge carriers. For example, organic materials such as polythiophene, derivatized polythiophene, oligomeric polythiophene, derivatized oligomeric polythiophene, pentacene, triphenylamine, and triphenyldiamine. EML 216 may also include semiconductors, such as silicon, gallium arsenide, cadmium selenide, or cadmium sulfide.

Second Electrode 217:

In the bottom-emitting configuration, the second electrode 217 functions as a cathode (the cathode is a conductive layer which serves as an electron-injecting layer and which comprises a material with a low work function). While the second electrode can be comprised of many different materials, preferable materials include aluminum, silver, gold, magnesium, calcium, cesium, barium, or combinations thereof. More preferably, the cathode is comprised of aluminum, aluminum alloys, or combinations of magnesium and silver. Additional cathode materials may contain fluorides such as LiF and the like. Second electrode 217 though shown as a single layer may be composed of a plurality of sub-layers composed of one or more of the above materials in any desirable combination.

The thickness of the second electrode 217 is from about 10 nm to about 1000 nm, preferably from about 50 nm to about 500 nm, and more preferably, from about 100 nm to about 300 nm. While many methods are known to those of ordinary skill in the art by which the second electrode 217 may be deposited, vacuum deposition and sputtering methods are preferred.

Refractive Layer 230

OLED device 205 as shown is a bottom-emitting OLED, and thus, the light emitted from the active EL layer 217 passes through the substrate 208. In accordance with various embodiments of the invention, a refractive layer 230 including features 232 is disposed on the exposed side of the substrate 208 (and thus, on the exterior of the OLED device 205) to enhance the total light output from EL device 200. In at least one embodiment of the invention, the refractive layer can be fabricated from or comprises an optical adhesive for the non-feature regions. In at least one embodiment of the invention, the features 232 are spherically shaped material with an inner region having a lower refractive index than non-feature regions of the refractive layer 230. The non-feature regions of the refractive layer 230 surrounding these features 232 will have a refractive index at least roughly the same as or greater than the refractive index as the substrate of the OLED device. In other embodiments of the invention, the features 232 are hollow excavations containing no added material and thus with a refractive index roughly equal to air (i.e. a refractive index of about 1.0).

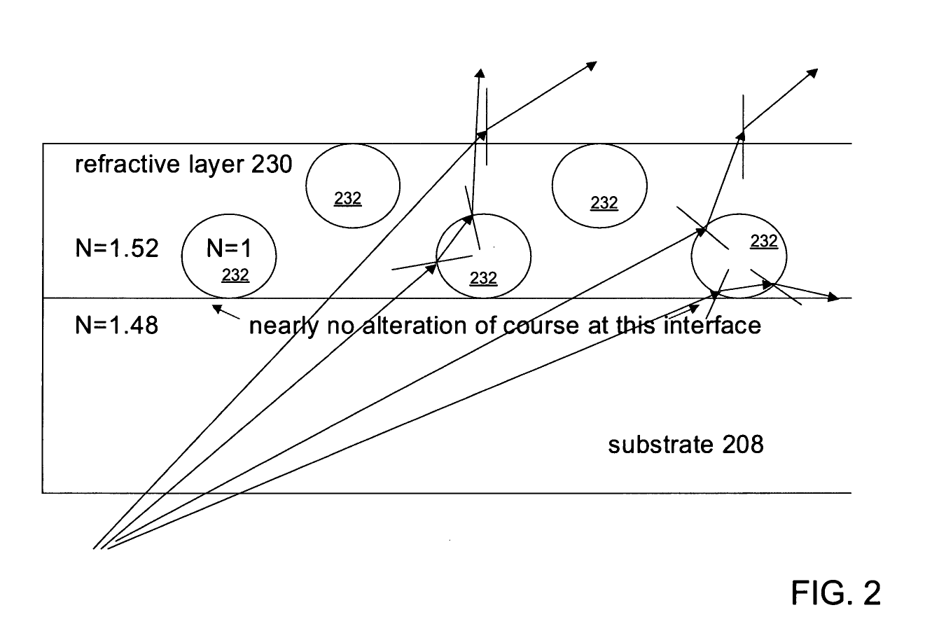

The chemical composition of the refractive layer 230 will depend upon the properties, e.g. the refractive index, of the substrate 208 from which light is passed to the refractive layer 230. For instance, if the substrate 208 is composed of a glass with a refractive index of about 1.48, the refractive index of the refractive layer 230 is preferably at or about 1.48. The features 232 are embedded or part of the refractive layer 230. Though shown spherical in geometry, in other embodiments of the invention, the geometry of the features 232 can be any suitable geometry to achieve diffusion or refraction of light. The features 232 are intended to redirect the light emitted from OLED device 205 by providing multiple refractions and reflections of light. This is illustrated in FIG. 2. For this purpose, features 232 may consist of hollow glass microspheres which are embedded or blended into refractive layer 230. For example, the features 232 may be Scotchlite Hollow Glass Microspheres available from 3M corporation. The remaining regions of the refractive layer 230 can be made, for example from an optically adhesive glue, which may additionally also be curable by ultraviolet radiation. For example, the refractive layer 230 can be fabricated from an optical adhesive available from Norland.

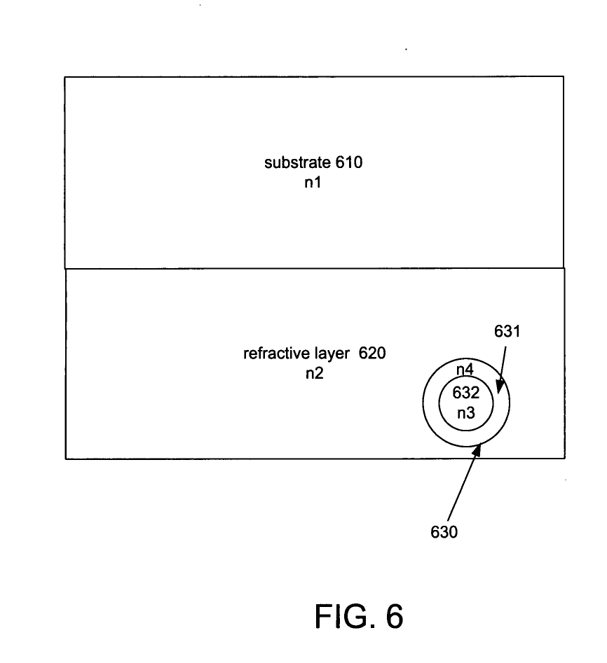

The features 232 in at least one embodiment of the invention has a diameter or average feature size of between 70 and 75 microns most preferably. In other embodiments of the invention, the feature size can be from 60 microns to 105 microns. In still other embodiments of the invention, the feature size can range from 100 nm to 500 microns. The refractive layer 230 itself may have a thickness ranging from about the feature size (or diameter) of features 232 to about 5 times the feature size for example. The feature size of features 232 is much larger than the wavelength of the emitted visible light. The features can have multiple regions of refraction as illustrated in FIG. 6.

Some embodiments utilize optical Gel layers instead of optical adhesives which also provide index matching with the substrate. Adhesives provide the additional benefit of mechanical strength. Optical Adhesives (self-curing or curable) or gels (non curing) are available from different sources.

The refractive layer 230 can be deposited or formed directly on substrate 208 or be separately prepared and attached onto substrate 208 by adhesives and/or curing. Further, the refractive layer 230 can utilize a cross-linkable material which can then be chemically bonded to the substrate 208. Deposition or application of the refractive layer may also be performed using a doctor blade technique, by spin coating, by printing, and so on.

The features in the refractive layer can be stirred into the material which is to surround it. For instance, the glass microspheres can be blended into the optical gel. The features may also be created by blowing bubbles into the non-feature material. In at least one embodiment, the features are included in the refractive layer prior to it being applied/deposited on the substrate. In some embodiments of the invention, the features could also be included in the refractive layer after the material with the same or greater refractive index as the substrate is deposited on the substrate.

FIG. 2 shows a cross-sectional view of exemplary light emission in accordance with at least one embodiment of the invention. Exemplary light rays are shown emerging from substrate 208. This illustrates the case of a bottom emitting OLED device where light is output from the OLED through the substrate (originating from the light emitting layer). The substrate 208 shown has a refractive index N of 1.48. In accordance with the invention, refractive layer 230 with features 232 is fabricated onto the substrate 208. The refractive layer 230 has a refractive index N of 1.52 for those regions that surround the features 232. This refractive index is roughly the same as the substrate. As a result light rays suffer nearly no alteration of course when passing through non-feature regions of refractive layer 230.

However, the spherical features 232 which are shown embedded or included in the refractive layer 230 have an internal region shown with a refractive index of nearly 1.0. Hollow bubbles and the like when used as features 232 can yield such refractive indices. When light rays enter features 232, they are refracted once. When the same light rays thereafter exit features 232 they are likely refracted yet again. As the light rays refracted by features 232 and those that simply pass through refractive layer 230 without refraction exit refractive layer 230, they will likely be refracted yet again (since it exits refractive layer 230 into air or other medium). The angle of refraction will depend upon the incident angle of the light rays. It is believed that this combination of refractions enhances the extraction of light from the substrate 208, and thus enhance the available output of light.

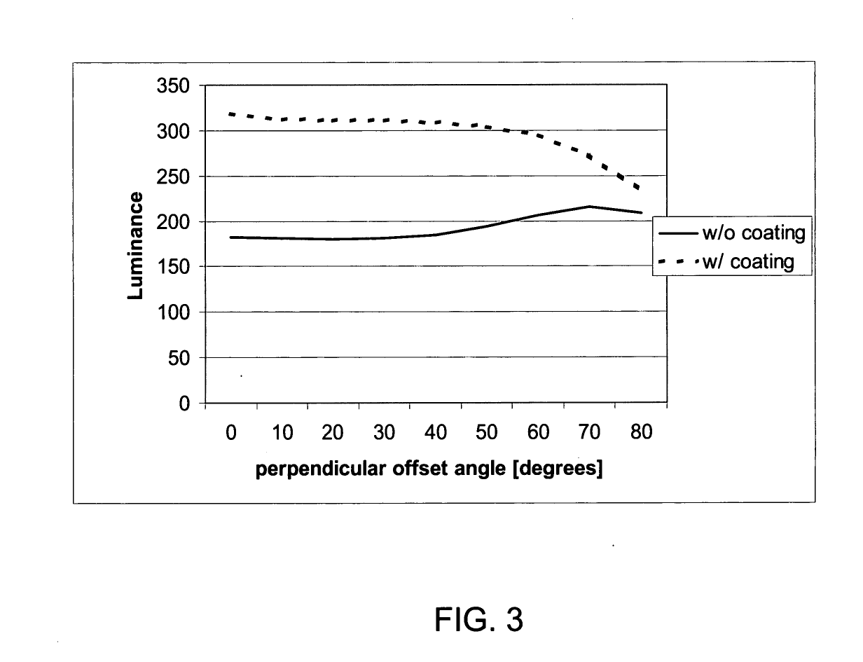

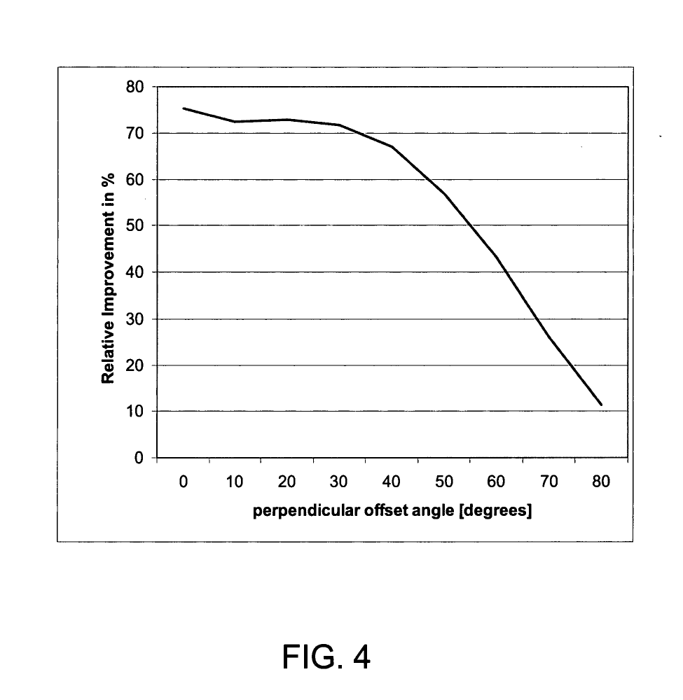

FIG. 3 illustrates the luminance enhancement compared to angular offset utilizing one or more embodiments of the invention. The graph of FIG. 3 has data sets. The first is “without coating” represented by the solid line. “Without coating” refers to a typical OLED device without any refractive layer attached thereto. In the “without coating” case, there is little angular dependence on the luminance output by the OLED device. The second data set illustrates the “with coating” case which is representative of one or more embodiments of the invention that uses the same OLED device as the “without coating” case, but also includes a refractive layer with features of lower refractive index. In the “with coating” case, there is a substantial improvement in output luminance at all viewing angles. FIG. 4 illustrates the relative luminance improvement at various viewing angles when the invention is utilized. All “offset angles” are measured against a line perpendicular (normal) to the emitting plane of the OLED device utilizing the invention. For example, the offset angle is zero if viewing straight down on top of the the emitting plane. The offset angle would be 90 degrees if you look parallel to the emitting plane. FIG. 4 shows the ratio of the two graphs in FIG. 3, hence showing the relative performance. Within the about an 80 degrees offset angle the relative improvement is equal or more that 10%. The more remarkable improvement of 70% happens in the range of 0 to 40 degrees offset angles. Thus, in an emitting cone of 80 degrees (40 degrees left and 40 degrees right of normal), the relative improvement is equal or more to 70%.

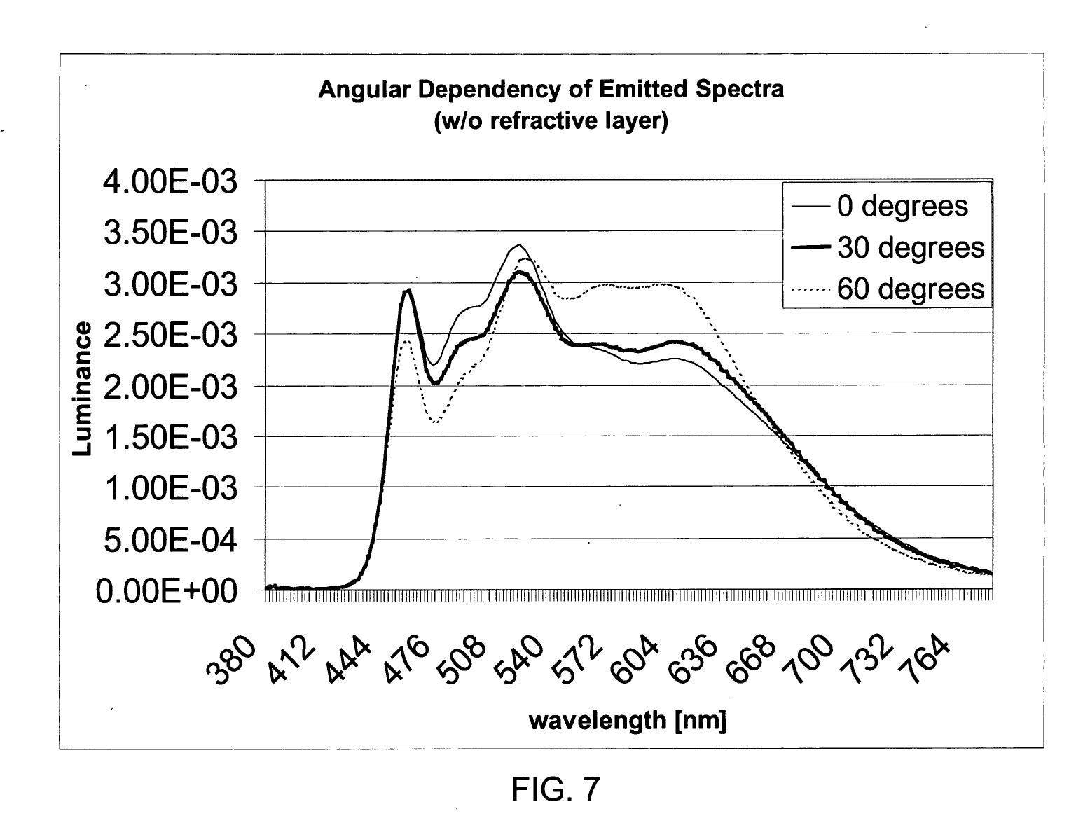

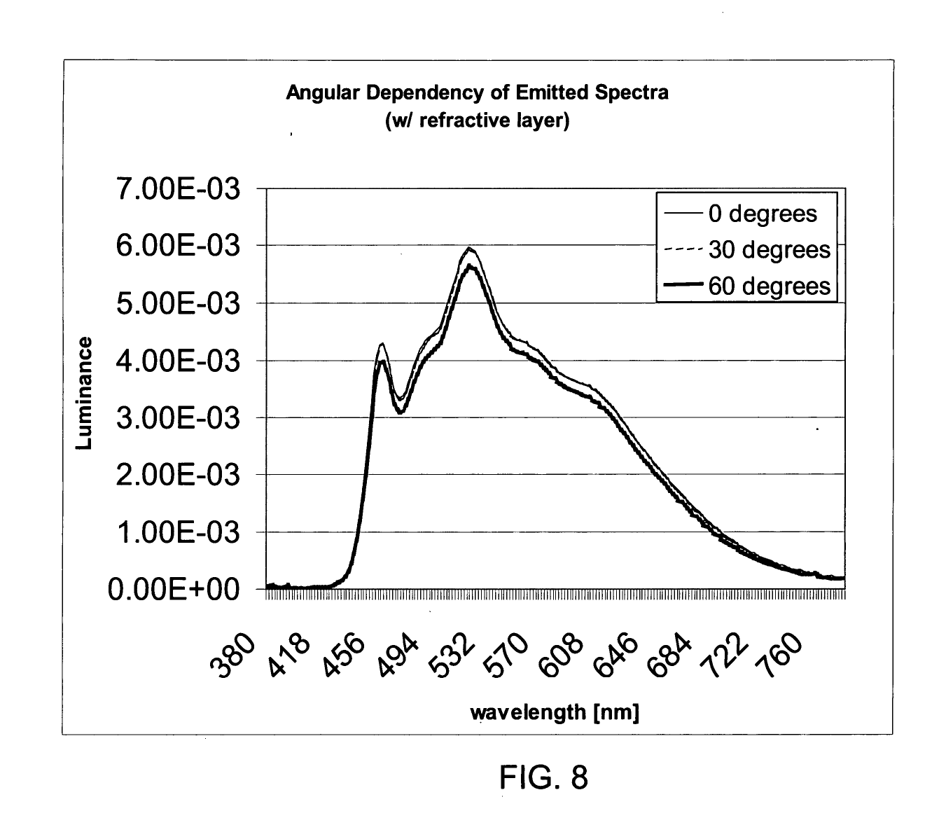

It has been shown also that at different wavelengths of emitted light, the angular dependence is roughly the same when a refractive layer is used (see FIG. 7 and FIG. 8). At different wavelengths (i.e. colors) of emission from the OLED device, it appears that the green parts of the spectra show the greatest improvement in luminance enhancement. The effect of luminance enhancement is visible over nearly the entire spectra.

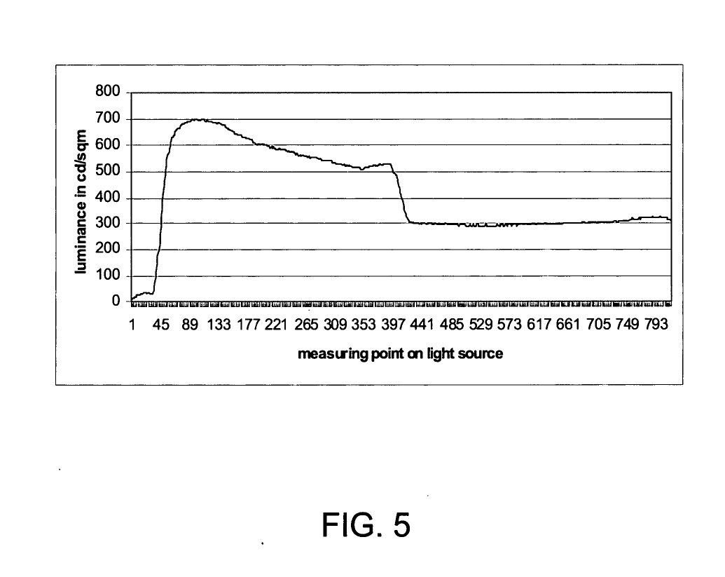

FIG. 5 shows a top view luminance distribution measured on an OLED white light source with and without the invention. The y-axis calibrated in nits, while the x-axis is the space coordinate when measuring across the OLED light source. The left domain (from x=0 to x=about 400) of the OLED light source was equipped with a refractive layer with features of lower refractive index in accordance with the invention. It can be seen that the luminance values are much higher in the left domain. Determination of the local averages for the luminance results in an approximately 70 percent higher value for the left domain. This confirms the result shown in FIG. 3 and FIG. 4. of a substantial improvement in total output luminance.

FIG. 6 illustrates one or more embodiments of the invention. In general, the invention comprises at least one refractive layer 630 which is fabricated and disposed over and on the outside of a substrate 610 of an OLED device. The refractive layer 630 is thus attached to the outside of the OLED device and not included as a part of the device. In this way, such a layer can be used on any OLED or similar lighting device independent of internal device structure. In a bottom-emitting OLED device light exits the OLED device via the substrate 610. The refractive layer 620 is placed in the path of light emission and thus, on the outside of the OLED device and on the outside of the substrate.

The refractive layer 620 has features 630 which are spherical or otherwise shaped pieces of material. The features 630 are blended into the refractive layer 620 or otherwise created therein through excavation, blowing and so on. The non-feature regions of refractive layer 620 surrounding features 630 have a refractive index of n2. The substrate 610 has a refractive index of n1. The features 630 can have one or more discrete regions. For example, in the case of a hollow glass sphere, there is the glass boundary between the non-feature regions of refractive layer 620 and the hollow part of the sphere. In one or more embodiments of the invention, the glass boundary of the hollow sphere comprising the features 630 are index matched with the other regions of the refractive layer 620. In the general case, however, and in other embodiments of the invention, the boundary is a separate region 631 which serves to separate the feature from the refractive layer. The boundary region 631 may be as thin or as thick as is desired and has a refractive index of n4. The feature 630 has interior region 632 with a refractive index of n3. In the various embodiments of the invention, the general order of preferred refractive indices for these regions will be n2>=n1 and n3<n2=<n4. Thus, there is the possibility that the refractive layer 620 provides refractions independent of and in addition to the refraction provided by feature 630. As well, in some embodiments of the invention, the boundary region 631 can provide its own refractive ability leading into and out of inner region 632.

FIG. 7 illustrates angular dependence of emitted spectra for OLED devices without a refractive layer. As shown, for typical OLED devices, there is a marked difference in luminance at various wavelengths depending upon the viewing angle. For instance, at around between 560 nm and 620 nm, a vieing angle of 60 degrees exhibits much greater luminance than at 0 or 30 degrees. Thus, the available luminance for displays and lighting sources based upon such emitting devices will show dependence on viewing angle. FIG. 8 illustrates angular dependence of emitted spectra for OLED devices with a refractive layer in accordance with the invention. If a refractive layer with features such as that discussed in one or more embodiments of the invention is used, the dependence of luminance upon viewing angle is greatly reduced. This effect is observable a almost all wavelengths. The units used for luminance in both FIG. 7 and FIG. 8 is Watts/sr/m².

Top Emitting OLED Devices

In an alternative configuration to that shown in FIG. 2 and described above, the first electrode 211 functions as a cathode (the cathode is a conductive layer which serves as an electron-injecting layer and which comprises a material with a low work function). The cathode, rather than the anode, is deposited on the substrate 208 in the case of, for example, a top-emitting OLED. Top emitting OLEDs can also have anodes in the opaque substrate and the cathode consists of transparent low work function materials. In this alternative configuration, the second electrode layer 217 functions as an anode (the anode is a conductive layer which serves as a hole-injecting layer and which comprises a material with work function greater than about 4.5 eV). The anode, rather than the cathode, is deposited on the semiconductor stack 214 in the case of a top-emitting OLED. Top emitting OLEDs can have cathodes as the transparent electrode and in this case cathode is deposited after the emissive layers.

In embodiments where the OLED is “top-emitting” as discussed above, the electrode (cathode 217) may be made transparent or translucent to allow light to pass from the EML 216. In such cases, the refractive layer 230 would be attached, bonded or cured to the cathode 217 (or to a glass or other material which encapsulates and protects the cathode) rather than to the substrate 208 as with a bottom-emitting OLED shown in FIG. 2.

The OLED lighting sources and displays produced from a combination or arrays of OLED devices described earlier can be used within applications such as information displays in vehicles, industrial and area lighting, telephones, printers, and illuminated signs.

As any person of ordinary skill in the art of light-emitting device fabrication will recognize from the description, figures, and examples that modifications and changes can be made to the embodiments of the invention without departing from the scope of the invention defined by the following claims.

What is claimed:

1. An apparatus, comprising:
an OLED device comprising a light emitting layer and a transparent layer capable of at least partially transmitting light from said light emitting layer and out from the OLED device; and
a refractive layer disposed over said transparent layer and on the exterior of said OLED device, said refractive layer comprising non-feature regions and a plurality of features, each of said features having an inner region and a boundary region, said boundary region the interface between said inner region and other features as well as said non-feature regions of said refractive layer, wherein the refractive index of said inner region is less than the refractive index of said non-feature regions.

2. The apparatus of claim 1 wherein the refractive index of said non-feature regions of said refractive layer is greater than the refractive index of said transparent layer.

3. The apparatus of claim 1 wherein the refractive index of said non-feature regions of said refractive layer is equal to the refractive index of said transparent layer.

4. The apparatus of claim 1 wherein the refractive index of said boundary region is greater than or equal to the refractive index of said non-feature regions of said refractive layer.

5. The apparatus of claim 1 wherein the refractive index of said boundary region is greater than the refractive index of said inner region.

6. The apparatus of claim 1 wherein said transparent layer is a substrate of said OLED device.

7. The apparatus of claim 1 wherein said each of features are spherical in geometry.

8. The apparatus of claim 1 wherein each of said features have an about equal size.

9. The apparatus of claim 1 wherein each of said features have a size ranging from about 60 to 105 microns.

10. The apparatus of claim 1 wherein each of said features have a size ranging from about 100 nanometers to 500 microns.

11. The apparatus of claim 1 wherein said features are composed of hollow microspheres.

12. The apparatus of claim 11 wherein said hollow microspheres have their boundary region composed of material matching the refrative index of said non-feature regions of said refractive layer.

13. The apparatus of claim 1 wherein said non-feature regions of said refractive layer are composed of an optical gel.

14. The apparatus of claim 13 wherein said optical gel is curable by ultraviolet radation.

15. The apparatus of claim 1 wherein said refractive layer is attached physically and/or chemically to said transparent layer.

16. The apparatus of claim 1 wherein said device is part of light source application.

17. The apparatus of claim 1 wherein said transparent layer is a cathode layer of said OLED device.

18. The apparatus of claim 1 wherein said inner region is air.

19. The apparatus of claim 1 wherein the thickness of the refractive layer is 1 to five times the size of said features.
